(19) United States
(12) Patent Application Publication
(10) Pub. No.: US 2014/0178026 A1
(43) Pub. Date: Jun. 26, 2014

(54) OPTICAL FIBER PROTECTOR

(71) Applicant: VOLCANO CORPORATION, San Diego, CA (US)

(72) Inventor: David Welford, Danvers, MA (US)

(73) Assignee: VOLCANO CORPORATION, San Diego, CA (US)

(21) Appl. No.: 14/133,166

(22) Filed: Dec. 18, 2013

Related U.S. Application Data
(60) Provisional application No. 61/745,381, filed on Dec. 21, 2012.

(51) Int. Cl. G02B 6/44; G02B 6/36

(52) U.S. Cl. CPC G02B 6/4429; G02B 6/3628
USPC 385/137; 29/428

(57) ABSTRACT

This invention generally relates to devices and methods for protecting an optical fiber during assembly of an optical system. In certain aspect, the invention provides an optical fiber protector. The optical fiber protector includes a first portion and a second portion. The first portion is configured to contact and couple to an optical fiber connector. The second portion is configured to couple to an optical component. The optical fiber protector further includes a bore for receiving at least a portion of an optical fiber there through.

### CROSS-REFERENCE TO RELATED APPLICATIONS

This application claims the benefit of, and priority to, U.S. Provisional Application Ser. No. 61/745,381, filed Dec. 21, 2012, the contents of which are incorporated by reference herein in its entirety.

### TECHNICAL FIELD

This invention generally relates to products for protecting optical fibers.

### BACKGROUND

Optical fibers are used in a variety of applications ranging from telecommunication networks to imaging systems, such as optical coherence tomography systems. In such systems, optical fibers are usually terminated and connected to optical components such as amplifiers, filters, optical connectors, detectors, switches and attenuators. Optical fibers often extend into or out of a housing of an optical component and are connected to other optical fibers as part of a series of optical components. Typically, an optical fiber extending from an optical component is coupled to and terminated at an optical connector. The terminated optical fiber is then connected directly to another optical component or connected to another optical fiber terminated at an optical connector via an adaptor.

A problem with optical fibers is that they are easily breakable because each fiber is very thin (having an outer diameter of about 100 to about 200 micrometers) and constructed of a fragile transparent core made of glass. During assembly of an optical system, many optical connections among different optical components are required, resulting in a significant amount of stress and strain being placed on the optical fibers. The damaging force applied on the optical fiber is exasperated when the optical fiber is connected between two optical components because both optical components apply tension, compression, and torsion to the optical fiber. That stress and strain is heightened when the optical fiber is short, which is often the case in compact optical systems or resonance optical systems, such as optical coherence tomography systems. The stress and strain applied to the optical fiber during system assembly can cause the optical fiber to break, which requires replacement of the optical fiber, and may even require replacement of the optical component if the component has the optical fiber built therein.

In addition, polishing a terminated end face of an optical fiber is often required to increase the transmissive properties of the fiber. Polishing may be required directly on the optical fiber itself or on the optical fiber disposed within an optical fiber connector. In the case of the optical fiber connector, the optical fiber is positioned within a ferrule of the connector and the ferrule/optical fiber are polished. Optical fibers often break during fiber polishing which likewise requires fiber and/or optical component replacement.

### SUMMARY

The invention generally relates to an optical fiber protector that provides support to an optical fiber and protects the optical fiber from breakage as a result of stress and strain applied to the fiber during assembly of an optical system and fiber polishing. The optical fiber protector acts as an intermediary connector between two optical components and provides a protective barrier around an optical fiber that is threaded through a bore in the protector. In this manner, the protector serves to limit stress and strain applied to the optical fiber due to the movement of either component. In addition, the optical fiber protector limits tension, compression, and torsion associated with polishing the optical fiber itself.

Products of the invention include an optical fiber protector that includes a first portion configured to contact and couple to an optical fiber connector, a second portion configured to directly couple to an optical component, and a bore for receiving at least a portion of the optical fiber there through. The first and second portions act to unite an optical fiber connector and an optical component in a manner that prevents movement of the components once a connection has been made, and thereby prevents the components from applying torque or other stress on the optical fiber. The bore allows the optical fiber to extend from the optical component, through the optical fiber protector and into the optical connector. The optical fiber protector can protect any optical fiber, including glass and/or polymeric fibers and single mode and/or multi-mode fibers.

In one embodiment, the first portion of the optical fiber protector includes an elongate member and the second portion includes a base member, e.g. a planar substrate, coupled to the elongate body member. The elongate member contacts and couples to an optical connector. The elongate member may further include at least two protrusions to form a recess. The recess receives a portion of the optical fiber connector to orient and stabilize the optical fiber connector, thereby preventing rotation or other movement. The planar substrate interfaces and connects directly to the optical component. Typically, the optical component includes a housing or exterior that couples to the planar substrate.

Generally, the bore extends linearly through the base member of the second portion and the elongate member of the first portion to provide a path for the optical fiber. In certain embodiments, a tubular member is at least partially disposed within the bore of the optical fiber protector and the tubular member extends beyond the optical fiber protector. The tubular member can be a hypotube, which may be composed of a stainless steel.

Any optical fiber connector is suitable for use with products and methods of the invention. For example, the optical fiber connector may be an LC connector. In one embodiment, the optical fiber connector includes a housing and a ferrule. At least a portion of the ferrule is disposed within a lumen of the housing. When the optical fiber is coupled to the optical fiber protector, the optical fiber connector is configured to receive a portion of the optical fiber extending from the optical component. In addition, the extended portion of the tubular member of the optical fiber protector may be sized to fit within the lumen of the plug housing. The tubular member can then extend into the optical connector and abut against the ferrule, which prevents the ferrule from compressing the optical fiber during polishing or optical assembly.

The optical fiber protector can be used in any optical system to protect the optical fiber extending between two optical components. The optical components can include filters, amplifiers, optical fiber connectors, etc. For example, the optical fiber protector can include a first portion configured to contact and couple to an optical connector and a second portion configured to directly couple to an optical filter. In certain embodiments, the optical system is an optical coherence tomography system.

Another aspect of the invention provides methods for connecting two optical components that involve providing an optical component having an optical fiber extending therefrom; providing an optical fiber protector including a first portion configured to contact and couple to an optical fiber connector; a second portion configured to directly couple to an optical component; and a bore for receiving at least a portion of an optical fiber there through; placing the optical fiber through the bore of the protector; coupling the protector to the optical component via the second portion; and coupling the first portion to an optical fiber connector that is coupled to a second optical component, thereby connecting two optical components.

### BRIEF DESCRIPTION OF DRAWINGS

FIG. 1 depicts an optical fiber protector according to an embodiment of the invention connected to an optical component and an optical connector according to one embodiment.

FIG. 2 depicts an optical fiber protector according to an embodiment.

FIG. 3 depicts an optical connector according to one embodiment.

FIG. 4 depicts a cross-sectional view of FIG. 1.

FIG. 5 depicts an optical fiber protector according to another embodiment.

### DETAILED DESCRIPTION

The invention generally relates to optical fiber protectors and methods of using those protectors to make connections among different optical components during assembly of an optical system. Optical fiber protectors of the invention have application in optical systems such as optical imaging devices and telecommunication devices. Protectors of the invention are particularly useful in compact optical systems or resonance optical systems, such as optical coherence tomography systems, where the optical fiber is short, which increases the stress and strain on the fiber.

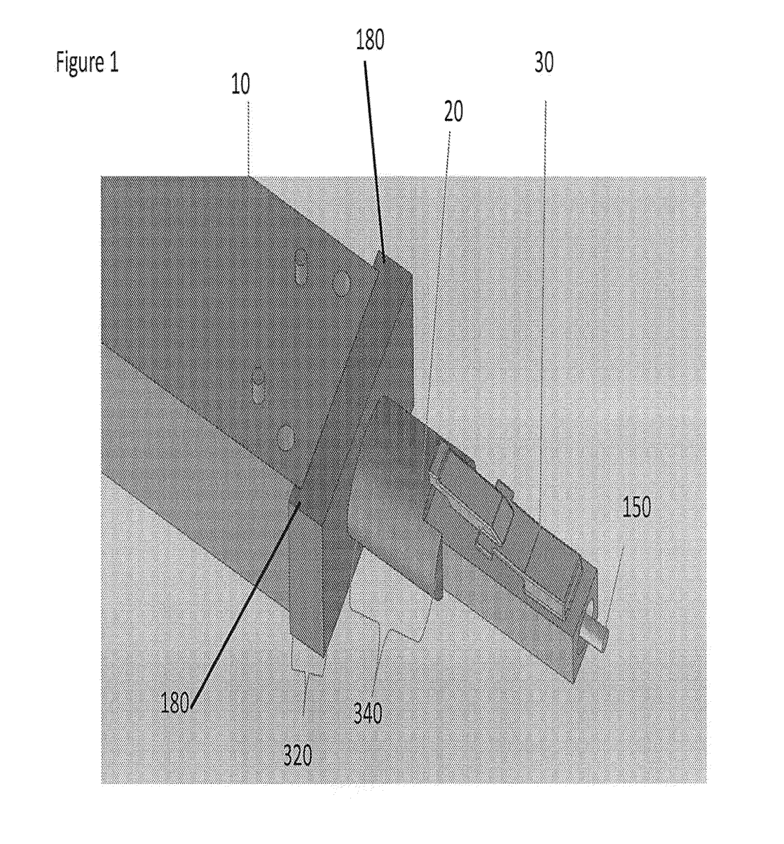

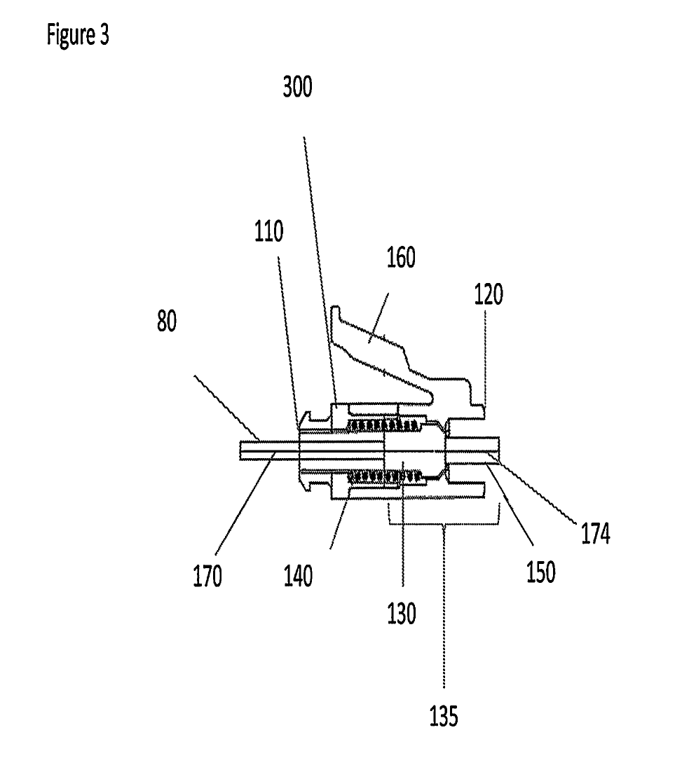

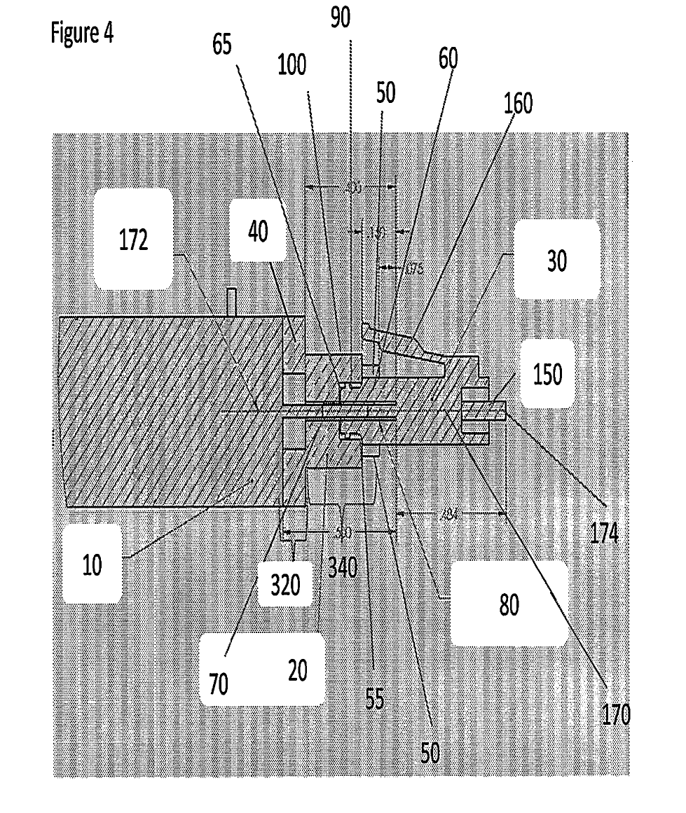

FIG. 1 depicts an embodiment of an optical fiber protector 20 as coupled to an optical component 10 and an optical fiber connector 30. As shown in FIG. 1, the optical fiber protector 20 is an intermediary between the optical component 10 and the optical fiber connector 30. The optical fiber protector 20 covers and protects an optical fiber (not shown) extending from the optical component 10 and into the optical fiber connector 30. The optical connector 30 includes a ferrule 150 extending from the optical fiber connector that surrounds the optical fiber, which is disposed in and extending from the optical connector 30. The ferrule 150 and optical connector 30 are discussed in more detail with respect to FIGS. 3 and 4. The optical fiber protector 20 prevents application of stress or strain on the optical fiber by stabilizing and uniting both the optical fiber connector 30 and the optical component 10 with respect to each other. Alternatively, the optical fiber protector can couple the optical component 10 to another optical component 10 instead of the connector 30 as shown in FIG. 1.

The optical fiber protector 20 can be coupled to the optical component 10 and the optical fiber connector 20 by any suitable fixation technique or fixing agent. Coupling may be performed by any number of known methods including, for example, laser welding, ultrasonic welding, heat stake, direct thermal bonding, low frequency induction heating, adhesive-laminated films, solvent bonding (e.g., acetone vapor), or mechanical bonding (e.g., press fit, screw, or similar). In one embodiment, adhesives, glues, adhesive resins or light curable adhesives/resins are used to couple the optical fiber protector 20 to the optical component 10 and the optical fiber connector 30. Adhesives and light curable adhesives/resins suitable for use with optical systems are described in detail in U.S. Pat. Nos. 6,151,433 and 4,744,619 and in Maruno, T. and Nakamura, K. (1991), Fluorine-containing optical adhesives for optical communications systems. J. Appl. Polym. Sci., 42: 2141-2148. doi: 10.1002/app. 1991.070420804; Hobbs, Philip CD. Building electro-optical systems: making it all work. Vol. 71. Wiley, 2011.

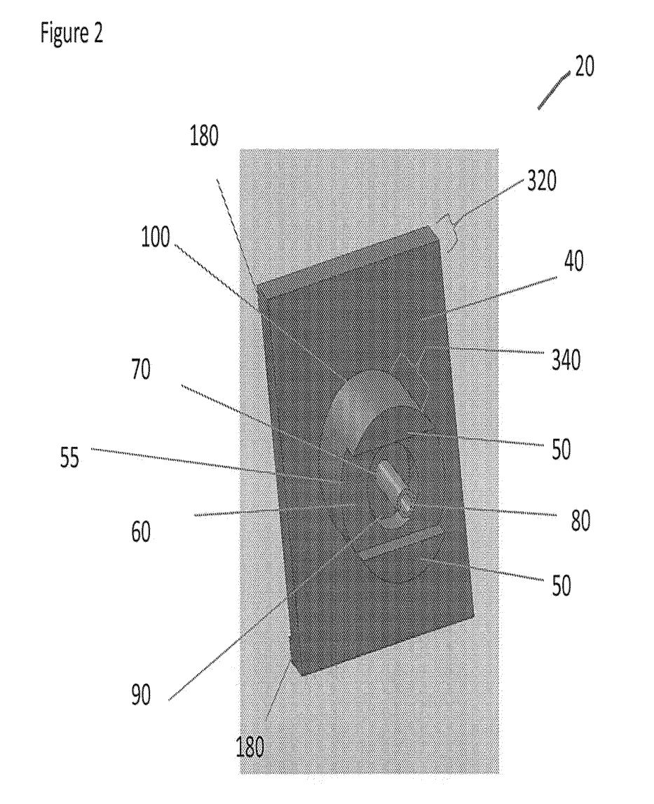

An embodiment of the optical fiber protector 20 is exemplified in FIG. 2. The optical fiber protector 20 generally has a first portion 340 and a second portion 320 (side view shown in FIG. 1). The optical fiber protector 20 includes a bore 70 having a hypotube 80 extending therefrom and through which the optical fiber (not shown) can extend. The bore extends through the first portion 340 and the second portion 320 to receive the optical fiber. The second portion 320 couples to the optical component 10 having an optical fiber extending therefrom. The first portion 340 receives the optical fiber from the second portion 320 and couples to the optical fiber connector 30. The optical fiber extends past the first portion 340 and enters into the optical fiber connector 30.

The optical fiber protector may be any size and have any dimensions. The length of the optical fiber protector 20 from a proximal end of the second portion 320 to a distal end of the first portion 340 depends on a desired length of the assembled unit (optical component/optical fiber protector/optical connector) and/or the length of the optical fiber extending from the optical component 10. For example, the optical fiber protector 20 can be sized so that the length of assembled unit is of a desired size and the optical fiber is or is capable of being (by trimming and polishing) flush with the egressing end of the optical connector 30.

The second portion 320 includes a base member 40 configured to couple to an optical component 10. The shape of the base member 40 can be designed to fit any optical component 10 used within any optical system. In certain embodiments, as shown in FIG. 1 and FIG. 2, the base member 40 is a planar substrate that has a rectangular/flat shape to mate with the rectangular body (i.e. housing) of the optical component 10. The base member can include extension members 180 that extend along the side of the body of the optical component 10. The extensions members 180 act to prevent rotation of the optical component 10 with respect to the optical fiber protector 20. Alternatively, the base member 40 can form a recess to receive at least a portion of the optical component 20 therein. In such aspect, the optical component 10 is placed into the recess and the walls of the base member 40 that form the recess contain the optical component 10. It is also contemplated that the base member 40 includes one or more snap fit features compatible with the optical component 10 that couple the optical connector 10 to the protector 20. The base member 40 also includes the bore 70 for receiving the optical fiber extending from the optical component 10.

As shown in FIG. 2, the first portion 340 of the optical fiber protector 20 includes an elongate member 100. Although the elongate member 100 is shown with a tubular shape, the elongate member 100 may be any shape or size. For example, the member 100 can be rectangular, semi-circular or shaped dependent on the type of optical component 10 or optical connector 30 one desires to couple to the elongate member 100. The elongate member 100 includes the bore 70 and surrounds an optical fiber extending from the optical component 10. A distal portion of the elongate member 100 defines a recess 60 for receiving at least a portion of the optical connector 30. The recess 60 can be formed by one or more protrusions 50 extending from the optical fiber protector 20 or the recess 60 can be formed within the body of the elongate member 100. The protrusions 50 and/or the body of the elongate member that defines the recess 60 increase the surface area of the elongate member 100 that couples to and contacts with the optical fiber connector 30. The protrusions 50 and/or body of the elongate member that defines the recess 60 also assist in orienting the optical fiber connector 30 and preventing rotation of the optical fiber connector 30 with respect to the optical fiber protector 20. The recess 60 forms a coupling surface 55 to receive and abut against a surface of the optical fiber connector 30.

In certain embodiments, the elongate member 100 further includes an additional cavity 90 formed within the elongate member to tailor-fit the shape of the optical fiber connector 30. As shown in FIG. 2, the elongate member 100 forms one additional cavity 90 to receive at least a portion of the optical fiber connector 30.

It is also contemplated that the elongate member 100 includes one or more snap fit features compatible with the optical connector 30 that couple the optical connector 30 to the protector 20. Snap fit connections are a means to mechanically fasten two components using an interlocking configuration. The interlocking configuration can include protuberance, such as a bump, hook, or bead, on one component and a depression or undercut formed in the other component that mates with the protuberance. For example, the protector 20 may have one or more depressions formed on protrusions 180 that mate with corresponding bumps on the optical component 10. The bumps enter the depressions formed on protrusions 180 and prevent the optical component 10 from being easily removed from the protector 20. Examples of snap fit connections are described in Handbook of Plastics Joining: A Practical Guide (1997).

In certain embodiments, the optical fiber protector 20 further includes a tubular member 80. While FIG. 2 shows the optical fiber protector 20 having the tubular member 80, it is not a required component of the protector 20, and in certain embodiments, the protector does not include tubular member 80. At least a portion of the tubular member 80 extends beyond the optical protector 20. For example, the tubular member 80 extends distally from the first portion 340 of the optical fiber protector 20 away from the second portion 320. In addition, the tubular member 80 can be disposed at least partially within or attached to a surface of the optical fiber protector 20. For example, the tubular member 80 may be disposed within both the first and second portions 340 and 320 of the optical fiber protector 20, or the tubular member 80 may be disposed only within the first portion 340.

The tubular member 80 is designed to further surround the optical fiber extending from the optical component 10 and protect the optical fiber from any torque applied by the optical connector 30. Preferably, the tubular member 80 abuts a portion of the optical connector 30 to prevent the optical connector 30 from applying compressive forces on the optical fiber. For example, an optical connector 30 typically includes a ferrule for receiving an optical fiber from the optical component 10. The tubular member 80 abuts a portion of the ferrule (e.g. a distal portion of the tubular member 80 abuts a proximal portion of the ferrule). When the optical fiber is disposed within a ferrule of the optical connector, the ferrule often compresses the optical fiber during polishing. The tubular member 80 abutting the ferrule prevents that compression. The ferrule and interaction of the ferrule with the tubular member 80 are discussed in more detail with regard to FIGS. 3 and 4.

The tubular member 80 can be any suitable material, including a metal, a stainless steel, a plastic, a glass, etc. In certain embodiments, the tubular member is a hypotube. The hypotube is preferably stainless steel.

In certain embodiments, the optical fiber protector 20 is coupled to an optical connector 30. Generally speaking, an optical connector is a mechanical device that is mounted to a terminated end of an optical fiber that provides an easy way to connect the optical fiber within an optical system via a socket. As used in accordance to the invention, the optical connector 30 is coupled to the optical fiber protector 20. Alternatively, the optical fiber protector 20 and the optical connector 30 can be formed as a single unit that connects directly to an optical component 10.

Any optical fiber connector is suitable for use with the optical fiber protector 20. Optical connectors typically include a housing, a ferrule assembly, and one or more other components for coupling the optical connector to an optical fiber. An example of an optical connector suitable for use in the invention is an LC connector. Examples of LC connectors are described in detail in U.S. Patent Publication Nos. 2011/0220985 and 2009/0269014. In certain embodiments, the optical connector only includes the housing and the ferrule assembly because the optical connector couples directly to the optical fiber protector, which eliminates the need for components that assist in connecting the optical connector to a fiber optic cable.

FIG. 3 depicts an exemplary optical connector 30 for use with the optical fiber protector 20 of the invention. The optical connector 30 includes a housing 300. The housing 300 can be shaped to fit into a socket of another optical component or into an optical adaptor, which is a two-way socket that optically connects optical connectors (places terminated end faces of optical fibers disposed within optical connectors in contact with each other). An example of an optical adaptor is described in U.S. Pat. No. 6,367,984. As shown in FIG. 3, a distal end 120 of the housing 300 is shaped to fit into a socket and a proximal end 110 of the housing 300 couples to the optical fiber protector 20. The housing 300 includes a latch arm 160 that is used to releasably lock the connector into a socket. The housing 300 defines a lumen for containing a ferrule assembly 135.

The ferrule assembly 135 includes a ferrule 150, a ferrule flange 130, and a spring 140. The ferrule 150 includes a channel extending down the length of its axis to closely receive an optical fiber 170 from the optical component 10. The ferrule 150 contains the optical fiber 170 within the channel. The ferrule can be any suitable material, and common materials used for ferrules include zirconia ceramics, polymers and composite polymers. At least a portion of the ferrule 150 is disposed within the housing 300 and at least a portion of the ferrule extends beyond the housing 300. Within the housing 300, the ferrule 150 is coupled to and/or partially disposed within a ferrule flange 130. The ferrule flange 130 attaches to the outer diameter of the ferrule 150 and provides a durable point of contact for securing the ferrule 150 within the connector housing 300. The ferrule flange 130 can be any suitable material, and common materials include polymers, composite polymers, stainless steel, and nickel plated brass. The spring 140 is coupled to the ferrule flange 140 and provides spring-loading of the ferrule assembly 135 to distally bias the ferrule 150 out of the optical connector 30. In certain embodiments, the spring 140 is not included in the ferrule assembly 135 because the tubular member 80 of the optical fiber protector 20 (as coupled to the optical connector 30) abuts against the ferrule flange 130 and biases the ferrule 150.

FIG. 4 shows a cross-sectional view of the optical protector 20 coupled to an optical component 10 and an optical connector 30. The base member 40 of the optical protector 20 is directly coupled to the optical component 10. The elongate member 100 of the optical protector 20 is directly coupled to the optical connector 30. As shown in FIG. 4, a portion of the optical connector 30 is disposed within the recess 60 of the elongate member 100 defined by protrusions 50 and a portion of the optical connector 30 is disposed within the cavity 90 of the elongate member 100. The protrusions 50 assist in orienting and preventing movement of the optical connector 30. As shown in FIG. 4, the optical connector 30 fits against a first surface 55 within recess 60 and a second surface 65 of the elongate member 100 within cavity 90. These contact surfaces increase the surface area for attachment between the optical connector 30 and optical fiber protector 20.

The optical fiber 170 has a proximal end 172 disposed within the optical component 10. The optical fiber 170 extends though the bore 70 and the tubular member 80 of the optical protector 20 (thus, passing through the second portion 320 and the first portion 340) and into the optical connector 30. A portion of the tubular member 80 extends into the optical connector 30 and abuts against the ferrule assembly 135 (not shown). Within the optical connector 30, the optical fiber 170 extends through the ferrule 150 of the ferrule assembly 135 and terminates at a distal end 174.

As shown in FIG. 4, the optical fiber 170 is completely encompassed within the optical component 10, optical fiber protector 20, and optical connector 30 and those elements are coupled to prevent unilateral motion of one of the elements from applying strain on the optical fiber 170. In certain aspects, at least a portion of the optical fiber 170 extends out the ferrule 150 prior to polishing. The extended optical fiber 170 is then trimmed and polished as necessary to create a terminated end face of the optical fiber that is suitable for an optical connection. During polishing, the optical fiber protector 20 prevents movement of the optical connector 30 to alleviate strain and torque on the optical fiber 170. In addition, the tubular member 80 abutted against the ferrule assembly 135 (not shown) prevents compression of the optical fiber 170.

Alternatively, the optical component 10 may include a pre-polished optical fiber 170. In such a case, the optical fiber protector 20 can be sized so that the terminated end of the optical fiber 170 is flush with the fiber egressing end of the ferrule 150.

In one aspect, the optical protector 20 is only coupled to an optical component 10 (not shown in Figures). In this aspect, the optical fiber protector 20 reduces strain applied directly to the optical fiber 170 that extends from the optical component 10. For example, when one desires to directly polish an optical fiber extending from the optical component. In this embodiment, the tubular member 80 of the optical fiber protector 20 can mirror the material, shape, and function of the ferrule within the optical fiber connector 30. During polishing, the optical fiber 170 is polished down to the tubular member 80.

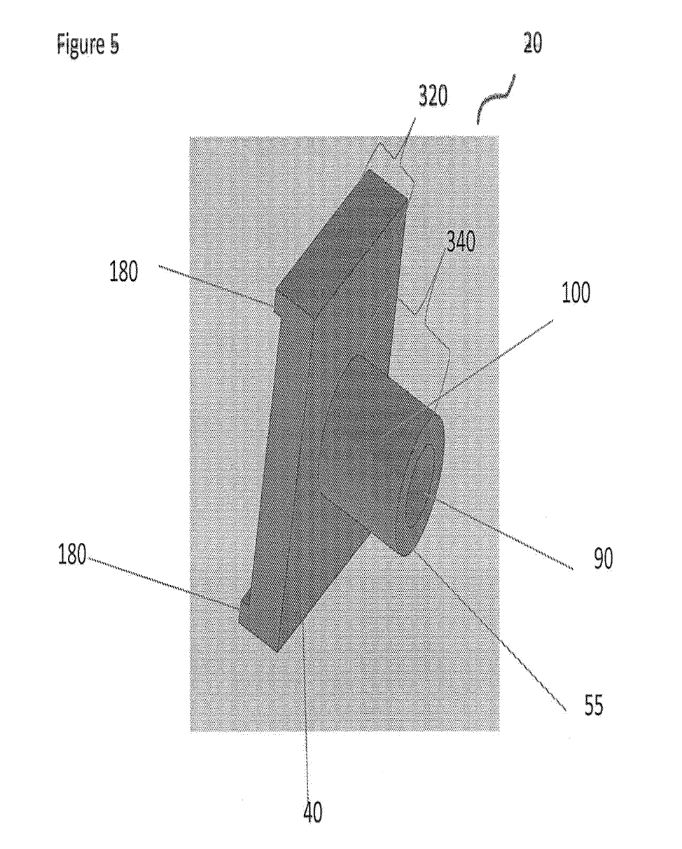

FIG. 5 depicts an alternative embodiment of the optical fiber protector 20, which includes a first portion 340 and a second portion 320. A bore (not shown) extends through the first portion 340 and the second portion 320 to receive an optical fiber. The first portion 340 of optical fiber protector 20 includes an elongate member 100 having a cavity 90 formed within the elongate member 100. The optical connector 30 couples to the elongate member 100. The cavity 90 may receive a portion of an optical connector 30 and can be sized to mate with the optical fiber connector 30. The body of the elongate member 100 acts to prevent motion of the optical fiber connector 30. In addition or alternatively, a portion of an optical connector 30 can be bonded to the surface 55 of the elongate member. The second portion includes a base member 40 designed to mate an optical component 10. In one embodiment, the base member 40 includes one or more extensions 180 that fit against an optical component 10 to prevent rotation.

The optical fiber protector 20 of the invention protects the optical fiber 170 against damage during polishing. Polishing techniques for optical fibers are generally specific to the type of optical connector 30 and optical fiber 170 used. However, all polishing techniques typically include placing the terminated end face of an optical fiber 170, which is protruding from the ferrule 150 of the optical connector 30, parallel to a polishing plate. The protruding optical fiber 170 is then ground against the polishing plate until the desired polish is achieved. The optical fiber protector 20 protects the optical fiber 170 because it reduces torque and compression applied to the optical fiber 170 by the optical component 10/optical protector 30 during polishing.

The optical fiber protector 20 of the invention can be coupled to any optical component 30 used in optical systems. Typically, the optical fiber protector 20 attaches to a housing or enclosure of the optical component 10. Optical components 10 include one or more optical fibers 170 are extending from the housing/enclosure of the optical component 10. Optical components 10 can be, for example, optical filters, amplifiers, collimators, and optical couplers. Exemplary optical components are described in more detail hereinafter.

Optical filters are optical components that selectively transmit light of a certain wavelength. Optical filters typical include an etalon, which is an optical cavity between two reflecting surfaces. The etalon can be two mirrors, which are closely spaced and parallel or a solid material low loss material such as a fused quartz or sapphire with two faces polished flat and parallel. The elation is typically placed within a filter body that includes an input optical fiber to deliver a light source and an output optical fiber to transmit the filtered light. An optical filter typically has a peak reflectivity and a background reflectivity. The peak reflectivity indicates an amount of light output (reflected) at the specified wavelength, wherein a desired wavelength can be set (in a tunable filter) by placing mirrors in an etalon an appropriate distance apart. The background reflectivity indicates an amount of light output at wavelengths other than the desired wavelength. Etalons are discussed in Laufer, G., Introduction to Optics and Lasers in Engineering 1996, 476 pages, Cambridge University Press, Cambridge, UK, the contents of which are incorporated by reference herein in their entirety (see, e.g., §6.5 The Fabry-Perot Etalon, pp. 156-162). Optical filters are discussed in U.S. Pat. No. 7,035,484; U.S. Pat. No. 6,822,798; U.S. Pat. No. 6,459,844; U.S. Pub. 2004/0028333; and U.S. Pub. 2003/0194165, the contents of each of which are incorporated by reference herein in their entirety. Any optical filter is suitable for use in methods of the invention. Exemplary optical filters include MICRON OPTIC filters and AXSUN TECHNOLOGIES filters.

In certain embodiments, the optical component is an optical amplifier. An optical amplifier is a device that amplifies an optical signal directly, without the need to first convert it to an electrical signal. An optical amplifier generally includes a gain medium (e.g., without an optical cavity), or one in which feedback from the cavity is suppressed. Exemplary optical amplifiers include doped fibers, bulk lasers, semiconductor optical amplifiers (SOAs), and Raman optical amplifiers. In doped fiber amplifiers and bulk lasers, stimulated emission in the amplifier's gain medium causes amplification of incoming light. In semiconductor optical amplifiers (SOAs), electron-hole recombination occurs. In Raman amplifiers, Raman scattering of incoming light with phonons (i.e., excited state quasi-particles) in the lattice of the gain medium produces photons coherent with the incoming photons.

The optical component may also be a collimator. A collimator is a device that narrows a beam of particles or waves, such as a beam of light. Collimators typically include a curved mirror or lens that narrow received light from a light source and transmit the narrowed light into an output optical fiber. The optical component may also be a collimator optical assembly having two fiber optic collimators facing each other, with the beam waist in the middle of the air gap. Collimators are described in, for example, U.S. Pat. Nos. 6,714,703, and 7,218,811.

In addition, the optical component may be a fiber optic coupler. Fiber optic couplers transfer input light from one or more input fibers to one or more output fibers. The light is typically passively transmitted from the input fibers to the output fibers. Fiber optic couplers or splitters can vary in performance, style, and sizes to split or combine light with minimal loss.

Optical components for use with products of the invention include one or more optical fibers to transmit light. The optical fibers can be single mode or multi-mode fibers. The optical fibers may be, for example, a glass, silica, or polymeric material. The optical fibers can range in length and diameter depending on the technological application. For example, optical fibers commonly used in optical coherence tomography (OCT) applications are single mode fibers with diameters that are less than 500 μm. Filters commonly used in OCT instruments include an optical fiber extending therefrom that has a diameter of 125 μm. Often it is desirable to design a compact optical system and the length of the optical fiber extending from the optical component is reduced to meet constraints. The invention is particular useful in protecting optical fibers having a length of about 20 mm or less, which often break optical system during assembly.

Exemplary optical systems suitable for use with products and methods of the invention are optical coherence tomography (OCT) systems. OCT is a medical imaging methodology using a specially designed catheter with a miniaturized near infrared light-emitting probe attached to the distal end of the catheter. As an optical signal acquisition and processing method, it captures micrometer-resolution, three-dimensional images from within optical scattering media (e.g., biological tissue). Commercially available OCT systems are employed in diverse applications, including art conservation and diagnostic medicine, notably in ophthalmology where it can be used to obtain detailed images from within the retina. The detailed images of the retina allow one to identify several eye diseases and eye trauma. Recently it has also begun to be used in interventional cardiology to help diagnose coronary artery disease. OCT allows the application of interferometric technology to see from inside, for example, blood vessels, visualizing the endothelium (inner wall) of blood vessels in living individuals.

Generally, an OCT system comprises three components which are 1) an imaging catheter 2) OCT imaging hardware, 3) host application software. When utilized, the components are capable of obtaining OCT data, processing OCT data, and transmitting captured data to a host system. OCT systems and methods are generally described in Castella et al., U.S. Pat. No. 8,108,030, Milner et al., U.S. Patent Application Publication No. 2011/0152771, Condit et al., U.S. Patent Application Publication No. 2010/0220334, Castella et al., U.S. Patent Application Publication No. 2009/0043191, Milner et al., U.S. Patent Application Publication No. 2008/0291463, and Kemp, N., U.S. Patent Application Publication No. 2008/0180683, the content of each of which is incorporated by reference in its entirety.

In OCT, a light source delivers a beam of light to an imaging device to image target tissue. Light sources can include pulsating light sources or lasers, continuous wave light sources or lasers, tunable lasers, broadband light source, or multiple tunable laser. Within the light source is an optical amplifier and a tunable filter that allows a user to select a wavelength of light to be amplified. Optical fibers are used to transmit light from the light source to the optical amplifier and the tunable filter. Short single mode optical fibers are often used in OCT applications because shorter fibers provide better resonance, which increases overall image quality. In addition, the short fibers provide for compact optical system design, which advantageously reduces the size of the OCT imaging device. Applying devices and methods the invention to OCT technology, one can minimize optical fiber breakage during assembly of the OCT optical system. This reduces the expensive costs associated with replacing the optical fiber and the optical components.

### INCORPORATION BY REFERENCE

References and citations to other documents, such as patents, patent applications, patent publications, journals, books, papers, web contents, have been made throughout this disclosure. All such documents are hereby incorporated herein by reference in their entirety for all purposes.

### EQUIVALENTS

Various modifications of the invention and many further embodiments thereof, in addition to those shown and described herein, will become apparent to those skilled in the art from the full contents of this document, including references to the scientific and patent literature cited herein. The subject matter herein contains important information, exemplification and guidance that can be adapted to the practice of this invention in its various embodiments and equivalents thereof.

What is claimed is:

1. An optical fiber protector comprising:
a first portion configured to contact and couple to an optical fiber connector;
a second portion configured to directly couple to an optical component; and
a bore for receiving at least a portion of an optical fiber there through.

2. The optical fiber protector of claim 1, wherein the first portion comprises an elongate member and the second portion comprises a planar substrate coupled to the elongate member.

3. The optical fiber protector of claim 2, wherein the bore extends linearly through the base member and the elongate member.

4. The optical fiber protector of claim 1, wherein the cap further comprises at least two protrusions extending from the first portion to form a recess, the recess configured to receive at least a portion of the optical fiber connector.

5. The optical fiber protector of claim 4, wherein the protrusions are configured to orient and stabilize the optical fiber connector to prevent rotation of the optical fiber.

6. The optical fiber protector of claim 1, further comprising a tubular member at least partially disposed within the bore of the protector, wherein a portion of the tubular member extends beyond the protector.

7. The optical fiber protector of claim 6, wherein the tubular member is a hypotube.

8. The optical fiber protector of claim 7, wherein the hypotube is composed of a stainless steel.

9. The optical fiber protector of claim 5, wherein the optical fiber connector comprises a plug housing and a ferrule, the plug housing defining a lumen and the ferrule is disposed within the lumen, the ferrule configured to receive a portion of the optical fiber.

10. The optical fiber protector of claim 8, wherein the extended portion of the tubular member is sized to fit within the lumen of the plug housing.

11. The optical fiber protector of claim 1, wherein the optical fiber connector is a LC connector.

12. The optical fiber protector of claim 1, wherein the optical component is an optical filter.

13. The optical fiber protector of claim 1, wherein the optical component is an optical amplifier.

14. An optical fiber protector configured to connect and couple to an optical fiber protector to orient the optical fiber connector and prevent compression of optical fiber.

15. A method for connecting two optical components, the method comprising:
providing an optical component comprising an optical fiber extending therefrom;
providing an optical fiber protector comprising: a first portion configured to contact and couple to an optical fiber connector; a second portion configured to directly couple to an optical component; and a bore for receiving at least a portion of an optical fiber there through;
placing the optical fiber through the bore of the protector;
coupling the protector to the optical component via the second portion; and
coupling the first portion to an optical fiber connector that is coupled to a second optical component, thereby connecting two optical components.

16. The method of claim 15, wherein the first portion comprises an elongate member and the second portion comprises a planar substrate coupled to the elongate member.

17. The method of claim 16, wherein the bore extends linearly through the base member and the elongate member.

18. The method of claim 15, wherein the first portion further comprises at least two protrusions extending from the first portion to form a recess, the recess configured to receive at least a portion of the optical fiber connector.

19. The method of claim 15, further comprising a tubular member at least partially disposed within the bore of the protector, wherein a portion of the tubular member extends beyond the protector.

20. The method of claim 19, wherein the tubular member is a hypotube.

21. The method of claim 20, wherein the hypotube is composed of a stainless steel.

22. The method of claim 19, wherein the optical fiber connector comprises a plug housing a ferrule, the plug housing defining a lumen and the ferrule is disposed within the lumen, wherein the ferrule is configured to receive a portion of the optical fiber.

23. The method of claim 22, wherein the extended portion of the tubular member is sized to fit within the lumen of the plug housing.

24. The method of claim 15, wherein the optical fiber connector is a LC connector.

25. The method of claim 15, wherein the optical component is an optical filter.

26. The method of claim 15, wherein the optical component is an optical amplifier.
